(19) United States
(12) Patent Application Publication
(10) Pub. No.: US 2026/0029638 A1
(43) Pub. Date: Jan. 29, 2026

(54) ILLUMINATION OPTICAL SYSTEM AND ENDOSCOPE

(71) Applicant: FUJIFILM Corporation, Tokyo (JP)

(72) Inventor: Keisuke HARADA, Saitama (JP)

(73) Assignee: FUJIFILM Corporation, Tokyo (JP)

(21) Appl. No.: 19/275,991

(22) Filed: Jul. 22, 2025

(30) Foreign Application Priority Data
Jul. 26, 2024 (JP) 2024-121362

(51) Int. Cl. G02B 23/24

(52) U.S. Cl. CPC G02B 23/2469

(57) ABSTRACT

An illumination optical system is disposed on an emission side of a light guide of an endoscope. In a case where a surface of the illumination optical system closest to a light guide side is defined as a first surface and a surface of the illumination optical system closest to an irradiation target side is defined as a second surface, an outer peripheral surface of the illumination optical system has a light reflecting surface on a first surface side and has a light absorbing surface on a second surface side. A stepped surface that is a surface perpendicular to an optical axis of the illumination optical system and that constitutes a step at which an outer diameter dimension changes is formed at a boundary between the light reflecting surface and the light absorbing surface. The first surface has a plurality of first concave surface portions.

### CROSS-REFERENCE TO RELATED APPLICATIONS

This application claims priority from Japanese Patent Application No. 2024-121362, filed on Jul. 26, 2024, the entire disclosure of which is incorporated herein by reference.

### BACKGROUND

### Technical Field

A technology of the present disclosure relates to an illumination optical system and an endoscope.

### Related Art

In the related art, as an illumination optical system that is disposed at a distal end portion of an insertion portion of an endoscope and illuminates a subject, for example, illumination optical systems described in JP2001-004927A and JP1987-287215B (JP-S62-287215B) are known.

### SUMMARY

In recent years, there has been a demand for an illumination optical system that is configured to be small, has wide light distribution, has less light distribution unevenness, and has good transmission efficiency.

The present disclosure provides an illumination optical system that is configured to be small, has wide light distribution, has less light distribution unevenness, and has good transmission efficiency, and an endoscope comprising the illumination optical system.

According to an aspect of a technology of the present disclosure, there is provided an illumination optical system disposed on an emission side of a light guide of an endoscope,
in which in a case where a surface of the illumination optical system closest to a light guide side is defined as a first surface, and a surface of the illumination optical system closest to an irradiation target side is defined as a second surface,
an outer peripheral surface of the illumination optical system from the first surface to the second surface has a light reflecting surface on a first surface side and has a light absorbing surface on a second surface side,
a stepped surface that is a surface perpendicular to an optical axis of the illumination optical system and that constitutes a step at which an outer diameter dimension changes is formed at a boundary between the light reflecting surface and the light absorbing surface,
the first surface has a plurality of first concave surface portions that have the same curvature radius and are provided at a small-diameter portion having a smaller diameter than a diameter of an outermost diameter portion at which an outer diameter of the illumination optical system is largest, and

Conditional Expressions (1), (2), and (3) represented by

0.4<C/H<0.95 (1),

0.45<D/(D+E)<0.95 (2), and

0.05<R1/H<0.5 (3) are satisfied.

Here, a radius of the small-diameter portion is defined as C. A radius of the outermost diameter portion is defined as H. A distance from a position closest to the light guide side on the first surface to the stepped surface in a direction of the optical axis is defined as D. A distance from an intersection point between the second surface and the optical axis to the stepped surface in the direction of the optical axis is defined as E. The curvature radius of the first concave surface portion is defined as R1.

It is preferable that the illumination optical system of the above-described aspect satisfies at least one of Conditional Expression (4), (5), (6), (7), or (8) below. Here, an interval between surface apexes of first concave surface portions adjacent to each other on the surface perpendicular to the optical axis is defined as P. A radius of the light guide is defined as G.

$$0.8 < ( C - P ) / D < 2 ( 4 ) \qquad ( 4 )$$

$$0.02 < ( 2 \times R 1 - P ) / C < 0.25 \qquad ( 5 )$$

$$0.04 < \frac{R 1 - \sqrt{R {1}^{2} - {( P / 2 )}^{2}}}{D} < 0.3 \qquad ( 6 )$$

$$0.9 < H / ( D + E ) < 1.5 \qquad ( 7 )$$

In the illumination optical system of the above-described aspect, it is preferable that at least one first concave surface portion includes a light diffusion surface.

The first surface may be configured to have at least one second concave surface portion having a larger curvature radius than a curvature radius of the first concave surface portion at a position closer to the optical axis than the first concave surface portion. In that case, it is preferable that the illumination optical system of the above-described aspect satisfies Conditional Expression (9). Here, a curvature radius of the second concave surface portion closest to the optical axis is defined as R2. A distance from an intersection point between the optical axis and the second concave surface portion closest to the optical axis to the second surface in the direction of the optical axis is defined as T.

$$0.55 < R 2 / T < 1.3 \qquad ( 9 )$$

According to another aspect of the technology of the present disclosure, there is provided an endoscope comprising a light guide and the illumination optical system of the above-described aspect.

In the present specification, “consist of” or “consisting of” is intended to mean that a lens that substantially does not have optical power, an optical element other than a lens, such as a stop, a filter, and a cover glass, a lens flange, a lens barrel, and the like may be included in addition to the illustrated constituents.

In the description of the present specification, “perpendicular” indicates being substantially perpendicular including an error generally allowed in the technical field to which the technology of the present disclosure belongs, in addition to being completely perpendicular. In the description of the present specification, “plane” indicates being a substantially plane including an error generally allowed in the technical field to which the technology of the present disclosure belongs, in addition to being a completely plane. In the description of the present specification, “the same” in “curvature radius is the same” indicates being substantially the same including an error generally allowed in the technical field to which the technology of the present disclosure belongs, in addition to being completely the same. The “curvature radius” in the present specification is a positive value.

According to the present disclosure, it is possible to provide an illumination optical system that is configured to be small, has wide light distribution, has less light distribution unevenness, and has good transmission efficiency, and an endoscope comprising the illumination optical system.

### BRIEF DESCRIPTION OF THE DRAWINGS

FIG. 1 is a cross-sectional view showing a configuration of an illumination optical system according to one embodiment, which corresponds to an illumination optical system of Example 1.

FIG. 2 is a plan view showing the configuration of the illumination optical system of FIG. 1.

FIG. 3 is a side view showing the configuration of the illumination optical system of FIG. 1.

FIG. 4 is a cross-sectional view showing the configuration and optical paths of the illumination optical system of FIG. 1.

FIG. 5 is a view for describing Comparative Example.

FIG. 6 is a diagram showing symbols of Conditional Expression.

FIG. 7 is a graph showing a light distribution characteristic of the illumination optical system of Example 1.

FIG. 8 is a cross-sectional view showing the configuration and optical paths of the illumination optical system of Example 2.

FIG. 9 is a plan view showing the configuration of the illumination optical system of Example 2.

FIG. 10 is a graph showing a light distribution characteristic of the illumination optical system of Example 2.

FIG. 11 is a cross-sectional view showing a configuration and optical paths of an illumination optical system of Example 3.

FIG. 12 is a plan view showing the configuration of the illumination optical system of Example 3.

FIG. 13 is a graph showing a light distribution characteristic of the illumination optical system of Example 3.

FIG. 14 is a cross-sectional view showing a configuration and optical paths of the illumination optical system of Example 4.

FIG. 15 is a plan view showing the configuration of the illumination optical system of Example 4.

FIG. 16 is a graph showing a light distribution characteristic of the illumination optical system of Example 4.

FIG. 17 is a cross-sectional view showing a configuration of an illumination optical system according to Modification Example, which corresponds to an illumination optical system of Example 5.

FIG. 18 is a cross-sectional view showing a configuration and optical paths of the illumination optical system of Example 5.

FIG. 19 is a plan view showing the configuration of the illumination optical system of Example 5.

FIG. 20 is a graph showing a light distribution characteristic of the illumination optical system of Example 5.

FIG. 21 is a cross-sectional view showing a configuration of an illumination optical system of Example 6.

FIG. 22 is a cross-sectional view showing the configuration and optical paths of the illumination optical system of Example 6.

FIG. 23 is a plan view showing the configuration of the illumination optical system of Example 6.

FIG. 24 is a graph showing a light distribution characteristic of the illumination optical system of Example 6.

FIG. 25 is a schematic configuration view of an endoscope according to one embodiment.

### DETAILED DESCRIPTION

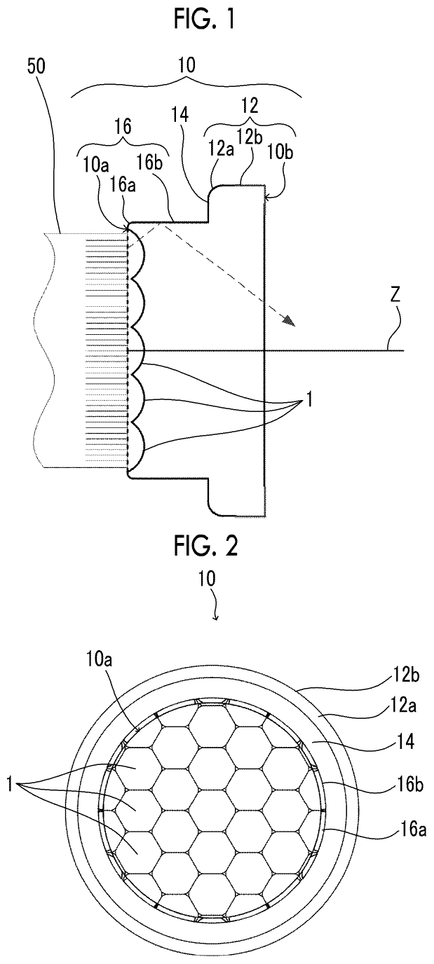

Embodiments of the present disclosure will be described in detail below with reference to the drawings. FIG. 1 shows a configuration in a cross section including an optical axis Z of an illumination optical system 10 according to one embodiment of the present disclosure. The illumination optical system 10 shown in FIG. 1 corresponds to Example 1 to be described later.

The illumination optical system 10 is an optical system disposed on an emission side of a light guide 50 of an endoscope. An end surface of the illumination optical system 10 is disposed to be in close contact with or close to a distal end of the light guide 50. The light guide 50 consists of a bundle fiber in which a plurality of optical fibers are bundled, and emits light, which is emitted from a light source (not shown), to the illumination optical system 10. That is, the light emitted from the light source is incident on the illumination optical system 10 via the light guide 50, is emitted from the illumination optical system 10, and serves as illumination light. In a case where the illumination optical system 10 is disposed at a distal end portion of an insertion portion of the endoscope, an irradiation target (not shown), which is an object to be observed, is illuminated with the above-described illumination light. FIG. 1 shows a cross-sectional view of the illumination optical system 10 including an optical axis Z, and a left side is a light source side and a right side is an irradiation target side.

As an example, the illumination optical system 10 shown in FIG. 1 consists of one optical element and has a rotation-symmetrical configuration with an optical axis Z as a rotation axis. Among surfaces of the illumination optical system 10, a first surface 10a is a surface of the illumination optical system 10 closest to a light guide side, and a second surface 10b is a surface of the illumination optical system 10 closest to the irradiation target side. As an example, the second surface 10b in FIG. 1 is a flat surface.

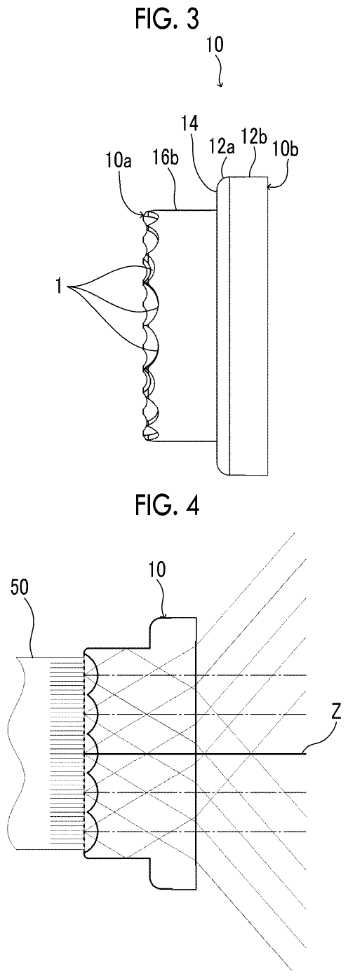

The first surface 10a has a plurality of first concave surface portions 1 having the same curvature radius. As an example, each first concave surface portion 1 in FIG. 1 has a spherical shape. Each first concave surface portion 1 causes a diverging action like a concave lens on incidence light. By forming the plurality of first concave surface portions 1 on the surface closest to the light guide side, there is an advantage in achieving wide light distribution while reducing a size of the illumination optical system 10, and it is also possible to contribute to reduction in light distribution unevenness. FIG. 2 shows a configuration of the illumination optical system 10 on a surface perpendicular to the optical axis Z as viewed from the light guide side. FIG. 3 shows the configuration of the illumination optical system 10 on a surface parallel to the optical axis Z.

As shown in FIG. 2, as an example, the first concave surface portion 1 of the present example is configured as follows. An outer shape of the first concave surface portion 1 on the surface perpendicular to the optical axis Z is substantially a regular hexagon. The plurality of first concave surface portions 1 having the same dimensions and the same shape are arranged in a honeycomb shape, and an interval between first concave surface portions 1 adjacent to each other is a predetermined interval. By providing the configuration as described above, the plurality of first concave surface portions 1 can be disposed at a high density, and an advantage of reducing light distribution unevenness is achieved.

Since the clad not emitting light, gaps between the fibers, and the core emitting light are arranged on the same surface on the emission end surface of the light guide 50 consisting of a bundle fiber, the emission end surface includes dark portions and bright portions. In a case where an image of an emission end surface of the light guide 50 is formed on the irradiation target, a pattern of light and shade is projected onto the irradiation target, and a significant light distribution unevenness occurs. In a case where the projection image of the pattern of light and shade is clear, there is a concern that the observation of the irradiation target may be hindered. By forming the plurality of first concave surface portions 1 on the surface closest to the light guide side, the occurrence of the projection image of the pattern of light and shade on the irradiation target can be suppressed.

In the technology of the present disclosure, at least one first concave surface portion provided on a surface of the illumination optical system closest to the light guide side may be configured to include a diffusion surface. Since the first concave surface portion includes the light diffusion surface, the spread of light emitted from the first concave surface portion can be increased, and thus the light distribution unevenness on the surface of the irradiation target can be reduced. In a case where the first concave surface portion is configured to include the light diffusion surface, the projection image of the pattern of the light and shade on the above-described irradiation target can be further suppressed by diffusing the ray with the light diffusion surface.

The light diffusion surface may be a roughened surface having fine unevenness, and may be, for example, a surface subjected to a sandblasting treatment by polishing. In addition, the light diffusion surface may be a surface on which a layer containing a substance having a light diffusion function, such as glass beads, is provided. The surface roughness of the light diffusion surface having fine unevenness can be typically set to a few μm or less in terms of arithmetic average roughness Ra.

Next, a configuration of a stepped structure and an outer peripheral surface of the illumination optical system 10 will be described. As shown in FIG. 1, the illumination optical system 10 has a stepped structure including a large-diameter portion 12 located on the irradiation target side and a small-diameter portion 16 located on the light guide side and configured to have a smaller diameter than a diameter of the large-diameter portion 12. A stepped surface 14 that is a flat surface perpendicular to the optical axis Z of the illumination optical system 10 and that constitutes a step at which an outer diameter dimension changes is formed between the small-diameter portion 16 and the large-diameter portion 12.

The large-diameter portion 12 includes a chamfered portion 12a, an outermost diameter portion 12b, and the second surface 10b. The chamfered portion 12a has a curved surface that connects the stepped surface 14 and a surface of the outermost diameter portion 12b. The outermost diameter portion 12b is a portion where an outer diameter of the illumination optical system 10 is the largest.

The small-diameter portion 16 includes the first surface 10a, a chamfered portion 16a, and a small-diameter step portion 16b. The chamfered portion 16a has a curved surface that connects the first surface 10a and a surface of the small-diameter step portion 16b. The small-diameter step portion 16b has a columnar shape having a generatrix parallel to the optical axis Z.

The outer peripheral surface of the illumination optical system 10 from the first surface 10a to the second surface 10b is configured such that the first surface side is a light reflecting surface and has a light absorbing surface on the second surface side. The stepped surface 14 is formed at a boundary between the light reflecting surface on the first surface side and the light absorbing surface on the second surface side.

In the present example, an outer peripheral surface of the small-diameter portion 16 is a light reflecting surface, and an outer peripheral surface of the large-diameter portion 12 is a light absorbing surface. In the present example, the outer peripheral surface of the small-diameter portion 16 is substantially the outer peripheral surface of the small-diameter step portion 16b, and the outer peripheral surface of the small-diameter step portion 16b is a mirror surface such as a surface of a lens surface. In FIG. 1, a ray emitted from one end of the light guide 50 and reflected by the surface of the small-diameter step portion 16b is indicated by a broken line with an arrow.

In the light reflecting surface on the first surface side, a reflectivity with respect to a ray having an incidence angle of 50 degrees or more is 80% or more among rays from an inside of the illumination optical system 10 toward the outer peripheral surface. The incidence angle is an angle between a normal line of the incident surface and the incident ray. In a case where the illumination optical system 10 is formed of glass, an interface between the glass and air can be used as the above-described light reflecting surface. The light reflecting surface may be further subjected to a coating for improving the reflectivity, for example, a mirror coating such as a vapor deposition film of aluminum or silver.

A light absorption rate is 50% or more on the light absorbing surface on the second surface side. The outer peripheral surface on the second surface side is often configured to be coated with an adhesive for preventing the component from falling off, and this configuration serves as a light absorbing surface.

Values of the above-described reflectivity and light absorption rate are values at the wavelength of light to be used. In a case where visible light is used as the light to be used, it is preferable that the values of the above-described reflectivity and the light absorption rate are secured, for example, in a wavelength range of 400 to 700 nm.

As described above, by making the outer diameter of the small-diameter portion 16 on the light guide side smaller than the diameter of the outermost diameter portion 12b and making the outer peripheral surface of the small-diameter portion 16 a light reflecting surface, it is possible to reduce the light loss on the outer peripheral surface of the large-diameter portion 12, which is advantageous for good transmission efficiency.

In FIG. 4, the optical paths of the illumination optical system 10 of FIG. 1 having the above-described configuration are shown by a solid line and a one-dot chain line. FIG. 4 shows a state of rays in a case where a plurality of rays emitted from a plurality of points on an emission end surface of the light guide 50 are incident on the illumination optical system 10. As shown in FIG. 4, the illumination optical system 10 in FIG. 1 realizes a wide light distribution angle.

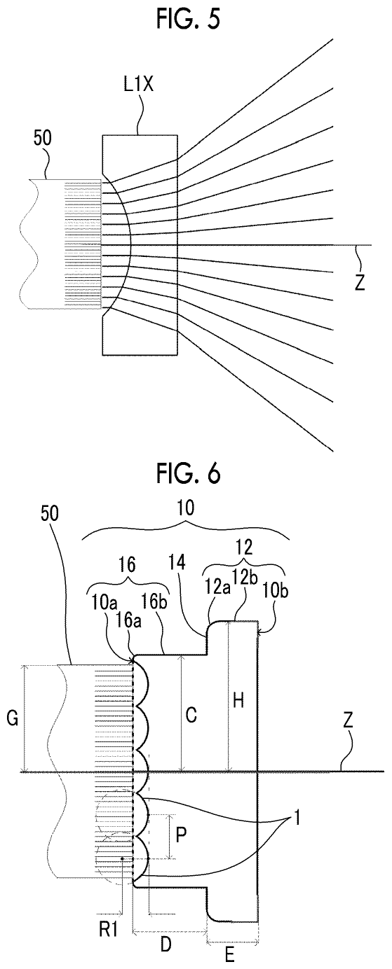

FIG. 5 shows a configuration and optical paths in a case where the illumination optical system 10 of FIG. 1 is temporarily replaced with a lens LIX as Comparative Example. The lens LIX in FIG. 5 is a negative lens in which only one concave surface is formed on the surface on the light guide side. In Comparative Example of FIG. 5, the spread angle of the ray emitted from the vicinity of the center portion of the light guide 50 is small, and the spread angle of the ray tends to increase as the emission position is farther from the center portion toward the outer diameter side. In this configuration, in a case where an outer diameter of the lens LIX is reduced for size reduction, there is a concern that rays with a large emission angle are incident on the outer peripheral surface of the lens LIX, the rays are blocked by the outer peripheral surface, and the rays cannot be used as illumination light. In Comparative Example of FIG. 5, it is required to increase the outer diameter of the lens LIX to some extent so that the ray is not blocked by the outer peripheral surface or the like of the lens LIX. That is, in Comparative Example of FIG. 5, it is difficult to achieve both size reduction and wide light distribution.

On the other hand, in the present example shown in FIG. 4, even in a case where the emission position of the ray in the light guide 50 is on the outer diameter side, the ray is reflected from the outer peripheral surface of the small-diameter portion 16 and can be used as illumination light. In addition, in the present example shown in FIG. 4, even in a case where the diameter of the small-diameter portion 16 on the light guide side is smaller than the diameter of the outermost diameter portion 12b, the ray is not blocked by the outer peripheral surface of the small-diameter portion 16, and the ray can be used as illumination light. As described above, in the present example shown in FIG. 4, it is easy to achieve both size reduction and wide light distribution, and good transmission efficiency can be obtained.

Next, a preferred configuration and a possible configuration of the conditional expression will be described. In the following description related to the conditional expressions, in order to avoid redundant description, the same symbol will be used for the same definition to partially omit duplicate descriptions of the symbol.

It is preferable that the illumination optical system 10 satisfies the following conditional expression (1). Here, a radius of the small-diameter portion 16 is defined as C. A radius of the outermost diameter portion 12b is defined as H. FIG. 6 shows the light guide 50 and the illumination optical system 10 of FIG. 1, and shows the above-described length radius C and radius H as an example. By not allowing a corresponding value of Conditional Expression (1) to be equal to or less than a lower limit value thereof, the increase in diameter of the outermost diameter portion 12b can be suppressed. Therefore, there is an advantage in achieving size reduction. By not allowing the corresponding value of Conditional Expression (1) to be equal to or greater than an upper limit value thereof, a light absorption amount on the outer peripheral surface of the large-diameter portion 12 can be suppressed. Therefore, there is an advantage in improving the transmission efficiency.

$$0.4 < C / H < 0 \text{.95} \qquad ( 1 )$$

In order to obtain more good characteristics, the lower limit value of Conditional Expression (1) is more preferably 0.5, still more preferably 0.6, and even more preferably 0.68. In order to obtain more good characteristics, the upper limit value of Conditional Expression (1) is more preferably 0.9, still more preferably 0.85, and even more preferably 0.83. For example, it is more preferable that the illumination optical system 10 satisfies at least one of Conditional Expression (1-1), (1-2), or (1-3) below.

$$0.5 < C / H < 0.9 \qquad ( 1 - 1 )$$

$$0.6 < C / H < 0.85 \qquad ( 1 - 2 )$$

$$0.68 < C / H < 0.83 \qquad ( 1 - 3 )$$

In addition, as shown in FIG. 6, in a case where the outer peripheral surface of the small-diameter portion 16 is substantially the outer peripheral surface of the small-diameter step portion 16b and the small-diameter step portion 16b has a columnar shape having a generatrix parallel to the optical axis Z, a radius of the small-diameter step portion 16b is constant. Therefore, the radius of the small-diameter step portion 16b is defined as C. Unlike the example in FIG. 6, for the illumination optical system in which the radius of the small-diameter portion 16 from the stepped surface 14 to the chamfered portion 16a is not constant, an average value of a maximum radius and a minimum radius of the small-diameter portion 16 in this range may be defined as C.

It is preferable that the illumination optical system 10 satisfies the following conditional expression (2). Here, a distance from the position closest to the light guide side on the first surface 10a to the stepped surface 14 in a direction of the optical axis Z is defined as D. The distance from an intersection point between the second surface 10b and the optical axis Z to the stepped surface 14 in the direction of the optical axis Z is defined as E. As an example, FIG. 6 shows the above-described distance D and distance E. By not allowing the corresponding value of Conditional Expression (2) to be equal to or less than the lower limit value thereof, a light absorption amount on the outer peripheral surface of the large-diameter portion 12 can be suppressed. Therefore, there is an advantage in improving the transmission efficiency. By not allowing the corresponding value of Conditional Expression (2) to be equal to or greater than the upper limit value thereof, the illumination optical system 10 is less likely to be broken. Therefore, there is an advantage in preventing damage.

$$0.45 < D / ( D + E ) < 0 \text{.95} \qquad ( 2 )$$

In order to obtain more good characteristics, the lower limit value of Conditional Expression (2) is more preferably 0.48, still more preferably 0.51, and even more preferably 0.55. In order to obtain more good characteristics, the upper limit value of Conditional Expression (2) is more preferably 0.85, still more preferably 0.75, and even more preferably 0.65. For example, it is more preferable that the illumination optical system 10 satisfies at least one of Conditional Expression (2-1), (2-2), or (2-3) below.

$$0.48 < D / ( D + E ) < 0 \text{.85} \qquad ( 2 - 1 )$$

$$0.51 < D / ( D + E ) < 0 \text{.75} \qquad ( 2 - 2 )$$

$$0.55 < D / ( D + E ) < 0 \text{.65} \qquad ( 2 - 3 )$$

In a case where a curvature radius of the first concave surface portion 1 is defined as R1, it is preferable that the illumination optical system 10 satisfies Conditional Expression (3) below. As an example, FIG. 6 shows the above-described curvature radius R1. By not allowing a corresponding value of Conditional Expression (3) to be equal to or less than the lower limit value thereof, the increase in diameter of the outermost diameter portion 12b can be suppressed. Therefore, there is an advantage in achieving size reduction. By not allowing the corresponding value of Conditional Expression (3) to be equal to or greater than the upper limit value thereof, the light is easily spread due to the refraction of the light in the first concave surface portion 1. Therefore, there is an advantage in achieving wide light distribution.

$$0.05 < R 1 / H < 0.5 \qquad ( 3 )$$

In order to obtain more good characteristics, the lower limit value of Conditional Expression (3) is more preferably 0.1, still more preferably 0.12, and even more preferably 0.14. In order to obtain more good characteristics, the upper limit value of Conditional Expression (3) is more preferably 0.4, still more preferably 0.3, and even more preferably 0.21. For example, it is more preferable that the illumination optical system 10 satisfies at least one of Conditional Expression (3-1), (3-2), or (3-3) below.

$$0.1 < R 1 / H < 0.4 \qquad ( 3 - 1 )$$

$$0.12 < R 1 / H < 0.3 \qquad ( 3 - 2 )$$

$$0.14 < R 1 / H < 0 \text{.21} \qquad ( 3 - 3 )$$

In a case where an interval between surface apexes of the first concave surface portions 1 adjacent to each other on the surface perpendicular to the optical axis Z is defined as P, it is preferable that the illumination optical system 10 satisfies Conditional Expression (4). As an example, FIG. 6 shows the above-described interval P. By not allowing the corresponding value of Conditional Expression (4) to be equal to or less than the lower limit value thereof, a value of C and a value of P are not excessively close to each other. Therefore, the number of first concave surface portions 1 formed on the first surface 10a is easily increased, which is advantageous for wide light distribution. By not allowing the corresponding value of Conditional Expression (4) to be equal to or greater than the upper limit value thereof, a light absorption amount on the outer peripheral surface of the large-diameter portion 12 can be suppressed. Therefore, there is an advantage in improving the transmission efficiency.

$$0.8 < ( C - P ) / D < 2 \qquad ( 4 )$$

In the present specification, in a case where a tangent plane to the first concave surface portion 1 at a certain point on the first concave surface portion is a plane perpendicular to the optical axis Z, the certain point is referred to as a “surface apex” of the first concave surface portion 1 for convenience. The concept of the “surface apex” can also be applied to a second concave surface portion described below. In FIG. 6, as an example, the above-described tangent plane that is a plane perpendicular to the optical axis Z is indicated by a two-dot chain line. In the example of FIG. 6, a point of the first concave surface portion 1 closest to the irradiation target side, that is, a point where a depth of the first concave surface portion 1 is the deepest is the above-described surface apex. Here, the “depth of the first concave surface portion 1” in the present specification refers to a distance from a point of the first concave surface portion 1 closest to the light guide side to a point of the first concave surface portion 1 closest to the irradiation target side in the direction of the optical axis Z.

In order to obtain more good characteristics, the lower limit value of Conditional Expression (4) is more preferably 0.82, still more preferably 0.84, and even more preferably 0.85. In order to obtain more good characteristics, the upper limit value of Conditional Expression (4) is more preferably 1.7, still more preferably 1.5, and even more preferably 1.3. For example, it is more preferable that the illumination optical system 10 satisfies at least one of Conditional Expression (4-1), (4-2), or (4-3) below.

$$0.82 < ( C - P ) / D < 1.7 \qquad ( 4 - 1 )$$

$$0.84 < ( C - P ) / D < 1.5 \qquad ( 4 - 2 )$$

$$0.85 < ( C - P ) / D < 1.3 \qquad ( 4 - 3 )$$

It is preferable that the illumination optical system 10 satisfies the following conditional expression (5). By not allowing the corresponding value of Conditional Expression (5) to be equal to or less than the lower limit value thereof, a gap between each first concave surface portion 1 is reduced, and the first concave surface portions 1 are easily disposed to be more densely arranged. Therefore, there is an advantage in achieving wide light distribution. By not allowing the corresponding value of Conditional Expression (5) to be equal to or greater than the upper limit value thereof, the depth of the first concave surface portion 1 can be made deeper, and thus the rays are more likely to be spread. Therefore, there is an advantage in achieving wide light distribution.

$$0.02 < ( 2 \times R 1 - P ) / C < 0.25 \qquad ( 5 )$$

In order to obtain more good characteristics, the lower limit value of Conditional Expression (5) is more preferably 0.03, still more preferably 0.04, and even more preferably 0.05. In order to obtain more good characteristics, the upper limit value of Conditional Expression (5) is more preferably 0.23, still more preferably 0.21, and even more preferably 0.2. For example, it is more preferable that the illumination optical system 10 satisfies at least one of Conditional Expression (5-1), (5-2), or (5-3) below.

$$0.03 < ( 2 \times R 1 - P ) / C < 0.23 \qquad ( 5 - 1 )$$

$$0.04 < ( 2 \times R 1 - P ) / C < 0.21 \qquad ( 5 - 2 )$$

$$0.05 < ( 2 \times R 1 - P ) / C < 0.2 \qquad ( 5 - 3 )$$

It is preferable that the illumination optical system 10 satisfies the following Conditional Expression (6). By not allowing the corresponding value of Conditional Expression (6) to be equal to or less than the lower limit value thereof, the depth of the first concave surface portion 1 can be made deeper, and thus the rays are more likely to be spread. Therefore, there is an advantage in achieving wide light distribution. In a case where the depth of the first concave surface portion 1 is excessively deep, the rays are excessively spread, and light absorption on the outer peripheral surface of the large-diameter portion 12 is likely to occur. Therefore, by not allowing the corresponding value of Conditional Expression (6) to be equal to or greater than the upper limit value thereof, the depth of the first concave surface portion 1 can be prevented from being excessively deep. As a result, the light absorption amount on the outer peripheral surface of the large-diameter portion 12 can be suppressed, which is advantageous for improving the transmission efficiency.

$$0.04 < \frac{R 1 - \sqrt{R {1}^{2} - {( P / 2 )}^{2}}}{D} < 0.3 \qquad ( 6 )$$

In order to obtain more good characteristics, the lower limit value of Conditional Expression (6) is more preferably 0.05, still more preferably 0.06, and even more preferably 0.07. In order to obtain more good characteristics, the upper limit value of Conditional Expression (6) is more preferably 0.25, still more preferably 0.2, and even more preferably 0.18. For example, it is more preferable that the illumination optical system 10 satisfies at least one of Conditional Expression (6-1), (6-2), or (6-3) below.

$$0.05 < \frac{R 1 - \sqrt{R {1}^{2} - {( P / 2 )}^{2}}}{D} < 0.25 \qquad ( 6 - 1 )$$

$$0.06 < \frac{R 1 - \sqrt{R {1}^{2} - {( P / 2 )}^{2}}}{D} < 0.2 \qquad ( 6 - 2 )$$

$$0.07 < \frac{R 1 - \sqrt{R {1}^{2} - {( P / 2 )}^{2}}}{D} < 0.18 \qquad ( 6 - 3 )$$

It is preferable that the illumination optical system 10 satisfies the following Conditional Expression (7). By not allowing the corresponding value of Conditional Expression (7) to be equal to or less than the lower limit value thereof, a light absorption amount on the outer peripheral surface of the large-diameter portion 12 can be suppressed. Therefore, there is an advantage in improving the transmission efficiency. By not allowing a corresponding value of Conditional Expression (7) to be equal to or greater than the upper limit value thereof, the increase in diameter of the outermost diameter portion 12b can be suppressed. Therefore, there is an advantage in achieving size reduction.

$$0.9 < H / ( D + E ) < 1.5 \qquad ( 7 )$$

In order to obtain more good characteristics, the lower limit value of Conditional Expression (7) is more preferably 0.93, further preferably 0.96, and further preferably 1. In order to obtain more good characteristics, the upper limit value of Conditional Expression (7) is more preferably 1.4, still more preferably 1.35, and even more preferably 1.3. For example, it is more preferable that the illumination optical system 10 satisfies at least one of Conditional Expression (7-1), (7-2), or (7-3) below.

$$0.93 < H / ( D + E ) < 1.4 \qquad ( 7 - 1 )$$

$$0.96 < H / ( D + E ) < 1.35 \qquad ( 7 - 2 )$$

$$1 < H / ( D + E ) < 1.3 \qquad ( 7 - 3 )$$

In a case where a radius of the light guide 50 is defined as G, it is preferable that the illumination optical system 10 satisfies Conditional Expression (8). As an example, FIG. 6 shows the above-described radius G. In a case where a diameter of the light guide 50 is not constant, the radius of the emission end surface of the light guide 50 is defined as G. By not allowing the corresponding value of Conditional Expression (8) to be equal to or less than the lower limit value thereof, the diameter of the first surface 10a can be made larger than the diameter of the light guide 50. Therefore, the occurrence of light leakage can be suppressed, and thus, there is an advantage in improving the transmission efficiency. By not allowing the corresponding value of Conditional Expression (8) to be equal to or greater than the upper limit value thereof, the effect of light reflection on the outer peripheral surface of the small-diameter portion 16 can be further enhanced.

$$1 < C / G < 1.5 \qquad ( 8 )$$

In order to obtain more good characteristics, the lower limit value of Conditional Expression (8) is more preferably 1.03, still more preferably 1.04, and even more preferably 1.05. In order to obtain more good characteristics, the upper limit value of Conditional Expression (8) is more preferably 1.4, still more preferably 1.3, and still more preferably 1.2. For example, it is more preferable that the illumination optical system 10 satisfies at least one of Conditional Expression (8-1), (8-2), or (8-3) below.

$$1.03 < C / G < 1.4 \qquad ( 8 - 1 )$$

$$1.04 < C / G < 1.3 \qquad ( 8 - 2 )$$

$$1.05 < C / G < 1.2 \qquad ( 8 - 3 )$$

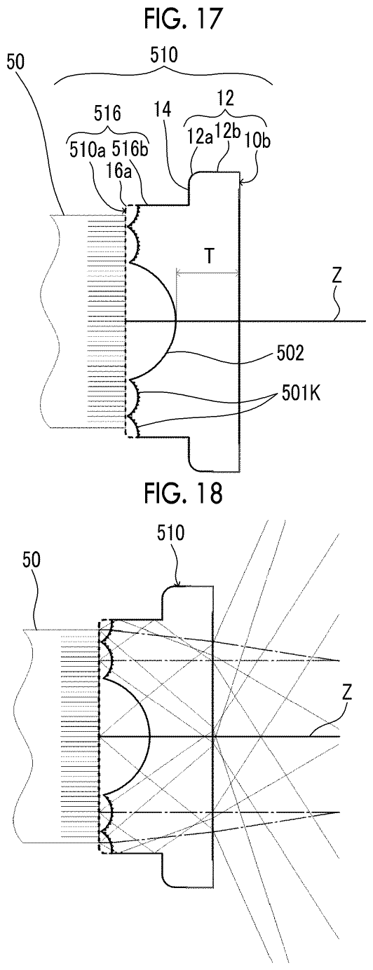

Next, Modification Example of the present disclosure will be described with reference to FIG. 17. FIG. 17 shows a configuration in a cross section including an optical axis Z of an illumination optical system 510 as one Modification Example of the present disclosure. The illumination optical system 510 shown in FIG. 17 corresponds to Example 5 to be described later. The illumination optical system 510 in FIG. 17 is significantly different as compared with the illumination optical system 10 in FIG. 1 in that the surface closest to the light guide side includes a second concave surface portion 502. In the following description of Modification Examples, the description will be mainly focused on this difference, and the same reference numerals will be assigned to the same configurations as those of the illumination optical system 10 of FIG. 1, and a part of the overlapping description will not be shown.

The illumination optical system 510 has a stepped structure including the large-diameter portion 12 located on the irradiation target side and a small-diameter portion 516 located on the light guide side and configured to have a smaller diameter than a diameter of the large-diameter portion 12. The stepped surface 14 that is a surface perpendicular to the optical axis Z of the illumination optical system 510 and that constitutes a step at which an outer diameter dimension changes is formed between the small-diameter portion 516 and the large-diameter portion 12.

The small-diameter portion 516 includes a first surface 510a, the chamfered portion 16a, and a small-diameter step portion 516b. The first surface 510a is a surface of the illumination optical system 510 closest to the light guide side. The chamfered portion 16a has a curved surface that connects the first surface 510a and a surface of the small-diameter step portion 516b. The small-diameter step portion 516b has a columnar shape having a generatrix parallel to the optical axis Z.

The first surface 510a has a plurality of first concave surface portions 501K having the same curvature radius and at least one second concave surface portion 502. The second concave surface portion 502 is located closer to the optical axis Z than the first concave surface portion 501K and has a curvature radius larger than a curvature radius of the first concave surface portion 501K. The second concave surface portion 502 causes a diverging action like a concave lens on the incidence light. As an example, FIG. 17 shows an example in which the first surface 510a has only one second concave surface portion 502, the second concave surface portion 502 has a spherical shape, and a surface apex of the second concave surface portion 502 is located on the optical axis.

The plurality of first concave surface portions 501K are disposed on an outer diameter side of the second concave surface portion 502 to surround the second concave surface portion 502. In addition, the first concave surface portion 501K is configured to have a light diffusion surface. In FIG. 17, a surface having a light diffusion surface is schematically shown as a surface with a large number of small dots, and this drawing method is the same in the drawings of other Examples described later. The first concave surface portion 501K has the same configuration as that of the first concave surface portion 1 in FIG. 1 except that the first concave surface portion 501K has a light diffusion surface.

In surgery using the endoscope, blood or the like may adhere to an illumination window provided on the irradiation target side from the illumination optical system. In a case where the intensity of illumination light is excessively high, there is a concern that blood adhered to the illumination window may be coagulated by the illumination light. In particular, illumination light on the optical axis and in the vicinity of the optical axis has a higher density of rays and a higher intensity of light as compared with illumination light in the vicinity of the outer diameter. In the present example, by disposing the second concave surface portion 502 having a curvature radius larger than the curvature radius of the first concave surface portion 501K closer to the optical axis Z than the first concave surface portion 501K, the density of rays on the optical axis and in the vicinity of the optical axis can be reduced. Accordingly, it is easy to prevent the blood adhered to the illumination window from being coagulated.

It is preferable that the illumination optical system 510 satisfies the following Conditional Expression (9). Here, a curvature radius of the second concave surface portion 502 is defined as R2. A distance from an intersection point between the second concave surface portion 502 and the optical axis Z to the second surface 10b in the direction of the optical axis Z is defined as T. As an example, FIG. 17 shows the above-described distance T. By not allowing the corresponding value of Conditional Expression (9) to be equal to or less than the lower limit value thereof, the curvature radius of the second concave surface portion 502 is not excessively close to the curvature radius of the first concave surface portion 501K, and the distance between the surface apex of the second concave surface portion 502 and the surface apex of the first concave surface portion 501K in an optical axis direction is not excessively shortened. Therefore, the density of the rays on the optical axis and in the vicinity of the optical axis can be reduced. Accordingly, it is easy to prevent the blood adhered to the illumination window from being coagulated. By not allowing the corresponding value of Conditional Expression (9) to be equal to or greater than the upper limit value thereof, a thickness of the illumination optical system 510 on the optical axis can be increased. Therefore, the illumination optical system 510 is less likely to be broken, which is advantageous for damage prevention.

$$0.55 < R 2 / T < 1.3 \qquad ( 9 )$$

In order to obtain more good characteristics, the lower limit value of Conditional Expression (9) is more preferably 0.6, still more preferably 0.65, and even more preferably 0.7. In order to obtain more good characteristics, the upper limit value of Conditional Expression (9) is more preferably 1.2, still more preferably 1.1, and even more preferably 1. For example, it is more preferable that the illumination optical system 510 satisfies at least one of Conditional Expression (9-1), (9-2), or (9-3) below.

$$0.6 < R 2 / T < 1.2 \qquad ( 9 - 1 )$$

$$0.65 < R 2 / T < 1.1 \qquad ( 9 - 2 )$$

$$0.7 < R 2 / T < 1 \qquad ( 9 - 3 )$$

In the example shown in FIG. 17, the first surface 510a has only one second concave surface portion 502, but the technology of the present disclosure is not limited thereto. The surface of the illumination optical system closest to the light guide side may have a plurality of second concave surface portions that are located closer to the optical axis Z than the first concave surface portion and that have a curvature radius larger than a curvature radius of the first concave surface portion. In that case, the above-described R2 is defined as a curvature radius of the second concave surface portion closest to the optical axis Z, and the above-described T is defined as a distance from an intersection point between the second concave surface portion closest to the optical axis Z and the optical axis Z to the second surface 10b in the direction of the optical axis Z.

In addition, it is preferable that the illumination optical system 510 according to Modification Example satisfies at least one of Conditional Expressions (1), (2), (3), (4), (5), (6), (7), or (8) described above.

In the above-described Modification Example, the first concave surface portion 501K has the light diffusion surface. However, the first surface 510a can be configured to have the second concave surface portion 502 and the first concave surface portion 501K can be configured to have no light diffusion surface.

The technology of the present disclosure is not necessarily limited to the examples shown in FIGS. 1 and 17, and various modifications can be made without departing from the spirit of the technology of the present disclosure.

For example, in FIG. 1, an example in which the illumination optical system 10 consists of one optical element is shown, but in the technology of the present disclosure, the illumination optical system may be configured to consist of a plurality of optical elements. The small-diameter portion and the large-diameter portion may be configured by separate optical elements, and these may be cemented to each other to configure the illumination optical system.

In FIG. 1, an example in which the first concave surface portion 1 has a spherical shape is shown, but in the technology of the present disclosure, the first concave surface portion may have an aspherical shape. In a case where the first concave surface portion has an aspherical shape, a paraxial curvature radius of the first concave surface portion may be defined as R1. Similarly, in FIG. 17, an example in which the second concave surface portion 502 has a spherical shape is shown, but in the technology of the present disclosure, the second concave surface portion may have an aspherical shape. In a case where the second concave surface portion has an aspherical shape, a paraxial curvature radius of the second concave surface portion may be defined as R2.

In FIG. 1, an example in which the outer shape of the first concave surface portion 1 on the surface perpendicular to the optical axis Z is substantially hexagonal is shown, but in the technology of the present disclosure, the outer shape of the first concave surface portion is not limited to this. In addition, FIG. 1 shows an example in which the first concave surface portions 1 are arranged in a honeycomb shape, but in the technology of the present disclosure, the method of disposing the first concave surface portions is not limited thereto.

Although FIG. 1 shows an example in which there is only one step where the outer diameter dimension changes, in the technology of the present disclosure, there may be a plurality of steps where the outer diameter dimension changes. In a case where there are a plurality of flat stepped surfaces that are a surface perpendicular to the optical axis Z of the illumination optical system and that constitute a step at which an outer diameter dimension changes, it is preferable that the stepped surface that is a boundary between the light reflecting surface and the light absorbing surface is a stepped surface closest to the irradiation target side. In such a case, it is advantageous to widen the area of the light reflecting surface as much as possible to obtain a higher transmission efficiency.

In FIG. 1, a configuration in which each of the large-diameter portion 12 and the small-diameter portion 16 includes the chamfered portions 12a and 16a is shown, but in the technology of the present disclosure, a configuration in which the chamfered portions are not included is also possible. In addition, the example of FIG. 1 does not include a chamfered portion between the outermost diameter portion 12b and the second surface 10b, but in the technology of the present disclosure, a chamfered portion may be provided in this portion.

The preferred configurations and the available configurations described in the above-described embodiments and Modification Examples can be combined in any combination within a range that does not contradict the configurations related to the Conditional Expressions, and it is preferable to selectively adopt the configurations according to the required specifications.

As an example, according to a preferred aspect of the illumination optical system of the present disclosure, there is provided an illumination optical system disposed on an emission side of a light guide of an endoscope, in which in a case where a surface of the illumination optical system closest to a light guide side is defined as a first surface, and a surface of the illumination optical system closest to an irradiation target side is defined as a second surface, an outer peripheral surface of the illumination optical system from the first surface to the second surface has a light reflecting surface on a first surface side and has a light absorbing surface on a second surface side, a stepped surface that is a surface perpendicular to an optical axis of the illumination optical system and that constitutes a step at which an outer diameter dimension changes is formed at a boundary between the light reflecting surface and the light absorbing surface, the first surface has a plurality of first concave surface portions provided at a small-diameter portion having a smaller diameter than a diameter of an outermost diameter portion at which an outer diameter of the illumination optical system is largest and that have the same curvature radius, and the above-described Conditional Expressions (1), (2), and (3) are satisfied.

Next, examples of the illumination optical system according to the embodiment of the present disclosure will be described with reference to the drawings. All of Examples 1 to 6 shown below consist of one optical element and have a rotationally symmetric configuration in which the optical axis Z is defined as a rotation axis.

### Example 1

The configuration of the illumination optical system 10 of Example 1 is shown in FIGS. 1, 2, and 3, the optical paths thereof are shown in FIG. 4, and the configuration thereof is as described above. Therefore, the repeated description will be partially omitted. In the illumination optical system 10, the first surface 10a, which is the surface closest to the light guide side, has the plurality of first concave surface portions 1 having the same curvature radius. The second surface 10b, which is the surface closest to the irradiation target side, is a flat surface. The stepped surface 14 perpendicular to the optical axis Z is formed at a boundary between the small-diameter portion 16 on the light guide side and the large-diameter portion 12 on the irradiation target side. The outer peripheral surface of the small-diameter portion 16 is a light reflecting surface, and the outer peripheral surface of the large-diameter portion 12 is a light absorbing surface.

Table 1 shows various types of data of the illumination optical system 10. Table 1 also shows the following values in addition to each value used in the above-described Conditional Expressions. “Sag1” is the depth of the first concave surface portion 1. “Rb” is a curvature radius of the second surface 10b. “Nd” is a refractive index of the optical element constituting the illumination optical system 10 at a d line. “vd” is an Abbe number of the optical element constituting the illumination optical system 10 based on the d line. A wavelength of the d line is treated as 587.56 nanometers (nm).

TABLE 1
Example 1

| | |
|---|---|
| C | 0.465 |
| H | 0.60 |
| D | 0.29 |
| E | 0.20 |
| G | 0.425 |
| R1 | 0.105 |
| P | 0.173 |
| Sag1 | 0.06 |
| Rb | ∞ |
| Nd | 1.4585 |
| νd | 67.82 |

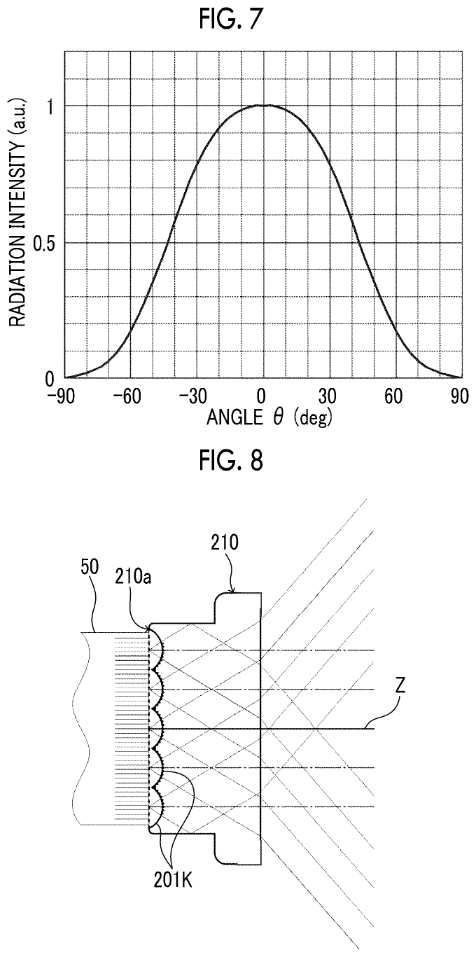

FIG. 7 shows a graph of the light distribution characteristics of the illumination optical system 10 of Example 1. In FIG. 7, the lateral axis is defined as an angle θ from the optical axis Z, and the vertical axis is defined as a radiation intensity. A half-width of this graph is summarized together with the values of other Examples in Table 7 described later.

The above-described symbols, meanings, description methods, and methods of showing each data related to Example 1 are basically the same for the following examples unless otherwise specified. Thus, duplicate descriptions will be omitted below.

In the data of each table in the present specification, a millimeter unit is used for lengths, and a degree unit is used for angles. However, since the optical system can also be proportionally enlarged or proportionally reduced to be used, other appropriate units can also be used. In addition, the values shown in the data of each table are values rounded to predetermined digits.

### Example 2

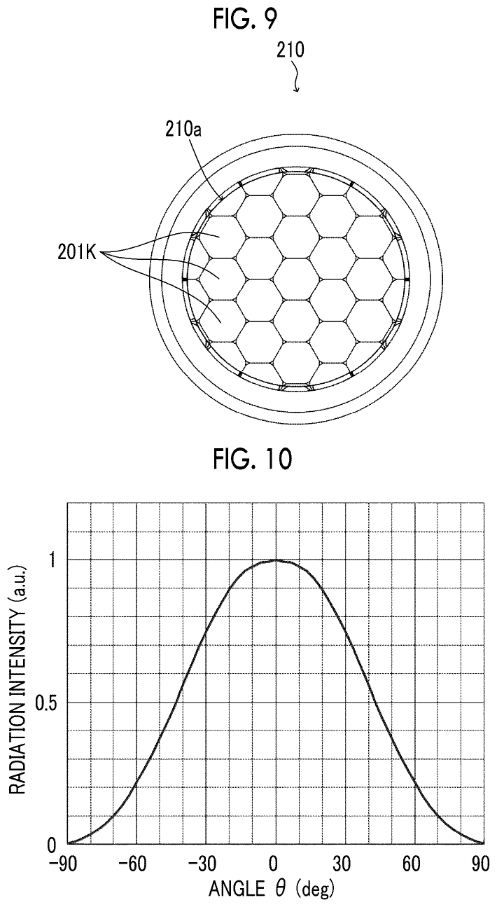

FIG. 8 shows a configuration and optical paths of an illumination optical system 210 of Example 2 in a cross section including the optical axis Z, and FIG. 9 shows a configuration on the surface perpendicular to the optical axis Z as viewed from the light guide side.

A first surface 210a of the illumination optical system 210 that is a surface closest to the light guide side has a plurality of first concave surface portions 201K having the same curvature radius. In the first surface 210a, a portion on the inner side with respect to a diameter of 0.76 millimeters (mm) is a light diffusion surface. The illumination optical system 210 is different as compared with the illumination optical system 10 of Example 1 in that the first concave surface portion 201K has a light diffusion surface, and other configurations are the same as those of the illumination optical system 10 of Example 1.

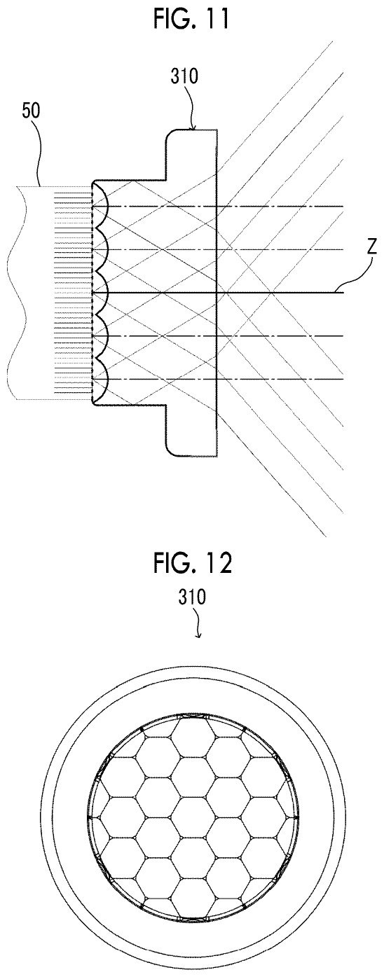

Various types of data of the illumination optical system 210 are shown in Table 2, and a graph of the light distribution characteristics is shown in FIG. 10.

TABLE 2
Example 2

| | |
|---|---|
| C | 0.465 |
| H | 0.60 |
| D | 0.29 |
| E | 0.20 |
| G | 0.425 |
| R1 | 0.105 |
| P | 0.173 |
| Sag1 | 0.06 |
| Rb | ∞ |
| Nd | 1.4585 |
| νd | 67.82 |

### Example 3

FIG. 11 shows a configuration and optical paths of an illumination optical system 310 of Example 3 in a cross section including the optical axis Z, and FIG. 12 shows a configuration on the surface perpendicular to the optical axis Z as viewed from the light guide side.

The illumination optical system 310 has substantially the same configuration as that of the illumination optical system 10 of Example 1, but has a configuration in which the radius of the small-diameter portion is smaller and the radius of the outermost diameter portion is larger as compared with those of the illumination optical system 10 of Example 1.

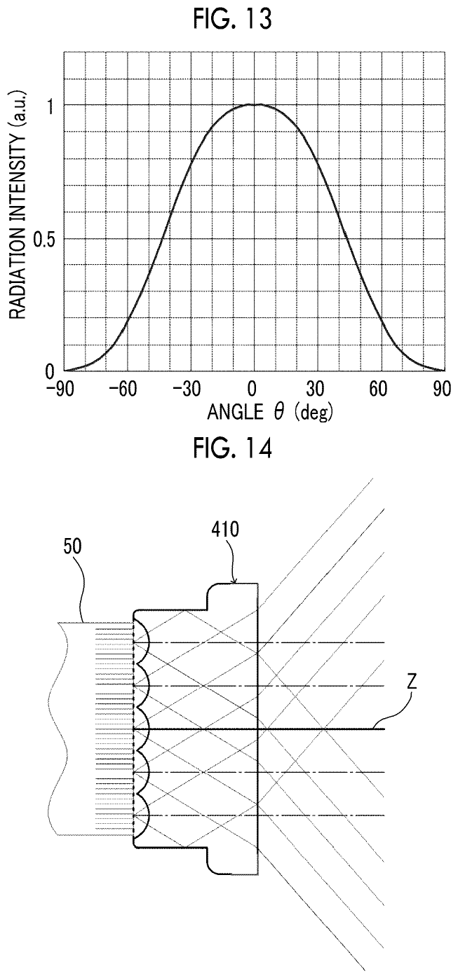

Various types of data of the illumination optical system 310 are shown in Table 3, and a graph of the light distribution characteristics is shown in FIG. 13.

TABLE 3
Example 3

| | |
|---|---|
| C | 0.450 |
| H | 0.65 |
| D | 0.29 |
| E | 0.20 |
| G | 0.425 |
| R1 | 0.105 |
| P | 0.173 |
| Sag1 | 0.06 |
| Rb | ∞ |
| Nd | 1.4585 |
| νd | 67.82 |

### Example 4

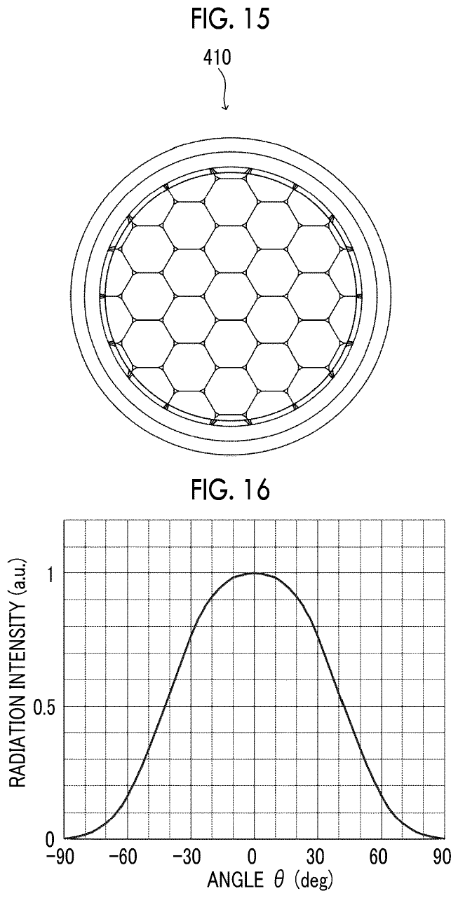

FIG. 14 shows a configuration and optical paths of an illumination optical system 410 of Example 4 in a cross section including the optical axis Z, and FIG. 15 shows a configuration on the surface perpendicular to the optical axis Z as viewed from the light guide side.

The illumination optical system 410 has substantially the same configuration as that of the illumination optical system 10 of Example 1, but the radius of the small-diameter portion is configured to be larger and the radius of the outermost diameter portion is configured to be smaller as compared with those of the illumination optical system 10 of Example 1.

Various types of data of the illumination optical system 410 are shown in Table 4, and a graph of the light distribution characteristics is shown in FIG. 16.

TABLE 4
Example 4

| | |
|---|---|
| C | 0.475 |
| H | 0.58 |
| D | 0.29 |
| E | 0.20 |
| G | 0.425 |
| R1 | 0.105 |
| P | 0.173 |
| Sag1 | 0.06 |
| Rb | ∞ |
| Nd | 1.4585 |
| νd | 67.82 |

### Example 5

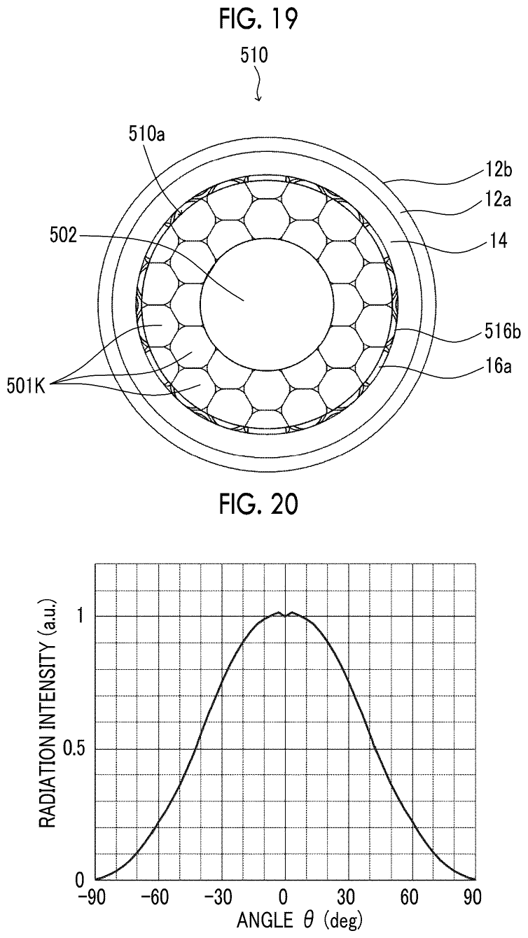

FIG. 17 shows a configuration of the illumination optical system 510 of Example 5 in a cross section including the optical axis Z, FIG. 18 shows a configuration and optical paths in a cross section including the optical axis Z, and FIG. 19 shows a configuration on the surface perpendicular to the optical axis Z as viewed from the light guide side.

The illumination optical system 510 has the configuration of the above-described Modification Example. Since the configuration of Example 5 is as described above in the description of Modification Example, some of the repeated description will not be shown here. The illumination optical system 510 is significantly different as compared with the illumination optical system 10 of Example 1 in that the first surface 510a has the second concave surface portion 502 and the first concave surface portion 501K has the light diffusion surface, and the other configurations are substantially the same.

The first surface 510a, which is the surface closest to the light guide side, has one second concave surface portion 502 and the plurality of first concave surface portions 501K having the same curvature radius. The second concave surface portion 502 has a curvature radius larger than a curvature radius of the first concave surface portion 501K. A surface apex of the second concave surface portion 502 is located on the optical axis. The plurality of first concave surface portions 501K are disposed on the outer diameter side of the second concave surface portion 502.

The second surface 10b, which is the surface closest to the irradiation target side, is a flat surface. The stepped surface 14 perpendicular to the optical axis Z is formed at a boundary between the small-diameter portion 516 on the light guide side and the large-diameter portion 12 on the irradiation target side. The outer peripheral surface of the small-diameter portion 516 is a light reflecting surface, and the outer peripheral surface of the large-diameter portion 12 is a light absorbing surface.

Various types of data of the illumination optical system 510 are shown in Table 5, and a graph of the light distribution characteristics is shown in FIG. 20. “D+E−T” in Table 5 is a distance from a point on the first surface 510a closest to the light guide side to the surface apex of the second concave surface portion 502 in the direction of the optical axis Z. The diameter of the second concave surface portion 502 is 0.47 millimeters (mm). In the first surface 510a, a portion on an outer diameter side with respect to a diameter of 0.47 millimeters (mm) is a light diffusion surface. That is, the first concave surface portion 501K has a light diffusion surface.

TABLE 5
Example 5

| | |
|---|---|
| C | 0.465 |
| H | 0.60 |
| D | 0.25 |
| E | 0.20 |
| G | 0.425 |
| R1 | 0.090 |
| P | 0.152 |
| Rb | ∞ |
| Nd | 1.4585 |
| νd | 67.82 |
| R2 | 0.240 |
| T | 0.250 |
| D + E − T | 0.2 |

### Example 6

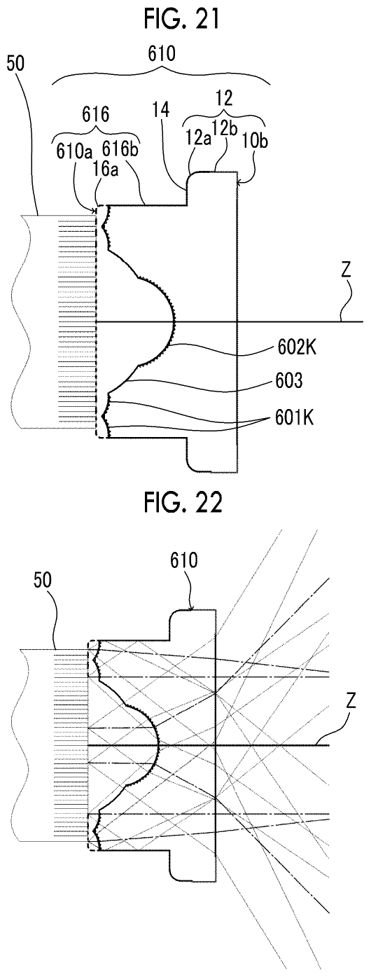

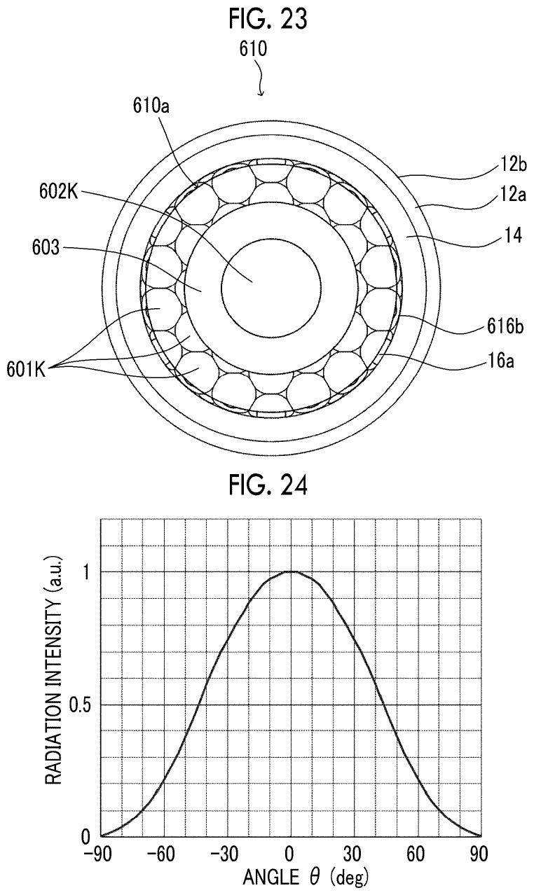

FIG. 21 shows a configuration of an illumination optical system 610 of Example 6 in a cross section including the optical axis Z, FIG. 22 shows a configuration and optical paths in a cross section including the optical axis Z, and FIG. 23 shows a configuration on the surface perpendicular to the optical axis Z as viewed from the light guide side.

The illumination optical system 610 of Example 6 has the above-described configuration of Modification Example. The illumination optical system 610 of Example 6 is significantly different as compared with the illumination optical system 510 of Example 5 in that a second concave surface portion 603 is provided, and the other configurations are substantially the same. The illumination optical system 610 has a stepped structure including the large-diameter portion 12 located on the irradiation target side and a small-diameter portion 616 located on the light guide side and configured to have a smaller diameter than a diameter of the large-diameter portion 12. The stepped surface 14 that is a surface perpendicular to the optical axis Z of the illumination optical system 610 and that constitutes a step at which an outer diameter dimension changes is formed between the small-diameter portion 616 and the large-diameter portion 12.

The small-diameter portion 616 includes a first surface 610a, the chamfered portion 16a, and a small-diameter step portion 616b. The first surface 610a is a surface of the illumination optical system 610 closest to the light guide side. The chamfered portion 16a has a curved surface that connects the first surface 610a and a surface of the small-diameter step portion 616b. The small-diameter step portion 616b has a columnar shape having a generatrix parallel to the optical axis Z.

The first surface 610a, which is the surface closest to the light guide side, has one second concave surface portion 602K, one second concave surface portion 603, and a plurality of first concave surface portions 601K having the same curvature radius. A surface apex of the second concave surface portion 602K is located on the optical axis. The substantially ring-shaped second concave surface portion 603 is disposed on the outer diameter side of the second concave surface portion 602K, and the plurality of first concave surface portions 601K are disposed on the outer diameter side of the second concave surface portion 603. The first concave surface portion 601K, the second concave surface portion 602K, and the second concave surface portion 603 cause a diverging action on incidence light. The second surface 10b, which is the surface closest to the irradiation target side, is a flat surface. The stepped surface 14 perpendicular to the optical axis Z is formed at a boundary between the small-diameter portion 616 on the light guide side and the large-diameter portion 12 on the irradiation target side. The outer peripheral surface of the small-diameter portion 616 is a light reflecting surface, and the outer peripheral surface of the large-diameter portion 12 is a light absorbing surface.

Various types of data of the illumination optical system 610 are shown in Table 6, and a graph of the light distribution characteristics is shown in FIG. 24. In Table 6, “R2” is a curvature radius of the second concave surface portion 602K. “T” is a distance from the surface apex of the second concave surface portion 602K to the second surface 10b in the direction of the optical axis Z. “D+E−T” is a distance from a point on the first surface 610a closest to the light guide side to the surface apex of the second concave surface portion 602K in the direction of the optical axis Z. “R3” is a curvature radius of the second concave surface portion 603. The diameter of the second concave surface portion 602K is 0.35 millimeters (mm). An inner diameter of the second concave surface portion 603 is 0.35 millimeters (mm), and the outer diameter thereof is 0.57 millimeters (mm). In the first surface 610a, a portion on the optical axis side with respect to a diameter of 0.35 millimeters (mm) and a portion on the outer diameter side with respect to a diameter of 0.57 millimeters (mm) are light diffusion surfaces. That is, the second concave surface portion 602K and the first concave surface portion 601K have a light diffusion surface.

The illumination optical system 610 has the second concave surface portion 603 in addition to the second concave surface portion 602K, and thus is advantageous in preventing blood from being adhering and coagulated on the illumination window as compared with the illumination optical system 510. In addition, in the illumination optical system 610, the second concave surface portion 602K has the light diffusion surface, and thus the illumination optical system 610 is advantageous in wide light distribution as compared with the illumination optical system 510.

TABLE 6
Example 6

| | |
|---|---|
| C | 0.465 |
| H | 0.60 |
| D | 0.36 |
| E | 0.20 |
| G | 0.425 |
| R1 | 0.120 |
| P | 0.152 |
| Rb | ∞ |
| Nd | 1.4585 |
| νd | 67.82 |
| R2 | 0.180 |
| T | 0.250 |
| D + E − T | 0.31 |
| R3 | 0.325 |

Table 7 shows the corresponding values of Conditional Expressions (1), (2), (3), (4), (5), (6), (7), or (8) of the illumination optical systems of Examples 1 to 6 and the corresponding values of Conditional Expression (9) of the illumination optical systems of Examples 5 and 6. In addition, the row of “θHWHM” in Table 7 shows the half-width of the graph of the light distribution characteristics of each Example. Preferable ranges of the conditional expressions may be set using the values shown in table 7 as upper limit values or lower limit values of the Conditional Expressions.

TABLE 7

| Expression | | | | | | | |
|---|---|---|---|---|---|---|---|
| number | | Example 1 | Example 2 | Example 3 | Example 4 | Example 5 | Example 6 |
| (1) | C/H | 0.775 | 0.775 | 0.692 | 0.819 | 0.775 | 0.775 |
| (2) | D/(D + E) | 0.59 | 0.59 | 0.59 | 0.59 | 0.56 | 0.64 |
| (3) | R1/H | 0.18 | 0.18 | 0.16 | 0.18 | 0.15 | 0.20 |
| (4) | (C − P)/D | 1.01 | 1.01 | 0.96 | 1.04 | 1.25 | 0.87 |
| (5) | (2 × R1 − P)/C | 0.08 | 0.08 | 0.08 | 0.08 | 0.06 | 0.19 |
| (6) | $\frac{R 1 - \sqrt{R {1}^{2} - {( P / 2 )}^{2}}}{D}$ | 0.16 | 0.16 | 0.16 | 0.16 | 0.17 | 0.08 |
| (7) | H/(D + E) | 1.22 | 1.22 | 1.33 | 1.18 | 1.33 | 1.07 |
| (8) | C/G | 1.09 | 1.09 | 1.06 | 1.12 | 1.09 | 1.09 |
| (9) | R2/T | | | | | 0.96 | 0.72 |
| | θHWHM | 43.3° | 43.0° | 43.7° | 42.3° | 42.6° | 43.8° |

As described above, all of the illumination optical systems of Examples 1 to 6 have a wide light distribution angle while being configured to be small.

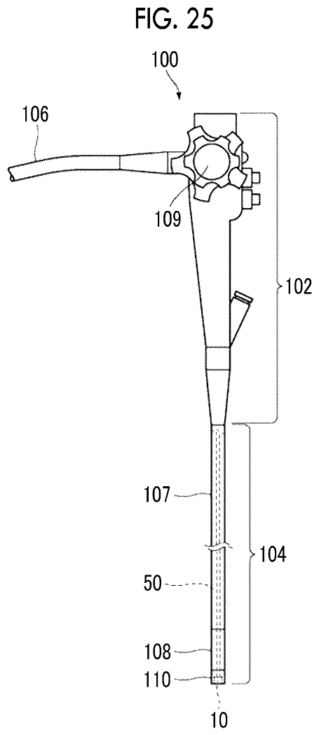

Next, an endoscope according to the embodiment of the present disclosure will be described. FIG. 25 is a schematic overall configuration view of the endoscope according to one embodiment of the present disclosure. An endoscope 100 shown in FIG. 25 mainly comprises an operating portion 102, an insertion portion 104, and a universal cord 106 that is to be connected to a connector portion (not shown). A large portion of the insertion portion 104 is a soft portion 107 that bends in any direction along an insertion path, a bendable portion 108 is connected to a distal end of the soft portion 107, and a distal end portion 110 is connected to a distal end of the bendable portion 108. The bendable portion 108 is provided to allow the distal end portion 110 to face a desired direction and can be operated to be bent by the rotational movement of a bending operation knob 109 provided at the operating portion 102.

The illumination optical system 10 according to one embodiment of the present disclosure is provided in a distal end of the distal end portion 110. In addition, the light guide 50 is disposed inside the endoscope such that the distal end of the light guide 50 faces the illumination optical system 10. In FIG. 25, the illumination optical system 10 is schematically shown, and the light guide 50 is partially omitted.

The technology of the present disclosure has been hitherto described through embodiments and examples, but the technology of the present disclosure is not limited to the above-described embodiments and examples, and can be modified into various forms. For example, the dimensions of each portion, the curvature radius of the first concave surface portion and the second concave surface portion, the refractive index of the optical element constituting the illumination optical system, the Abbe number, and the like are not limited to the above-described values shown in Examples and may take other values.

Regarding the above-described embodiments and examples, the following appendices will be further disclosed.

### APPENDIX 1

An illumination optical system disposed on an emission side of a light guide of an endoscope,
wherein in a case where a surface of the illumination optical system closest to a light guide side is defined as a first surface, and a surface of the illumination optical system closest to an irradiation target side is defined as a second surface,
an outer peripheral surface of the illumination optical system from the first surface to the second surface has a light reflecting surface on a first surface side and has a light absorbing surface on a second surface side,
a stepped surface that is a surface perpendicular to an optical axis of the illumination optical system and that constitutes a step at which an outer diameter dimension changes is formed at a boundary between the light reflecting surface and the light absorbing surface,
the first surface has a plurality of first concave surface portions that have the same curvature radius and are provided at a small-diameter portion having a smaller diameter than a diameter of an outermost diameter portion at which an outer diameter of the illumination optical system is largest, and
in a case where a radius of the small-diameter portion is defined as C,
a radius of the outermost diameter portion is defined as H,
a distance from a position on the first surface closest to the light guide side to the stepped surface in a direction of the optical axis is defined as D,
a distance from an intersection point between the second surface and the optical axis to the stepped surface in the direction of the optical axis is defined as E, and
the curvature radius of the first concave surface portion is defined as R1,
Conditional Expressions (1), (2), and (3) represented by

0.4<C/H<0.95 (1),

0.45<D/(D+E)<0.95 (2), and

0.05<R1/H<0.5 (3) are satisfied.

### APPENDIX 2

The illumination optical system according to appendix 1, wherein in a case where an interval between surface apexes of the first concave surface portions adjacent to each other on the surface perpendicular to the optical axis is defined as P,

### APPENDIX 3

The illumination optical system according to appendices 1 or 2,
wherein in a case where an interval between surface apexes of the first concave surface portions adjacent to each other on the surface perpendicular to the optical axis is defined as P,
Conditional Expression (5) represented by 0.02< (2×R1−P)/C<0.25 (5) is satisfied.

### APPENDIX 4

The illumination optical system according to any one of appendices 1 to 3,
wherein in a case where an interval between surface apexes of the first concave surface portions adjacent to each other on the surface perpendicular to the optical axis is defined as P,
Conditional Expression (6) represented by

$$0.04 < \frac{R 1 - \sqrt{R {1}^{2} - {( P / 2 )}^{2}}}{D} < 0.3 \qquad ( 6 )$$

is satisfied.

### APPENDIX 5

The illumination optical system according to any one of appendices 1 to 4,
wherein Conditional Expression (7) represented by 0.9<H/(D+E)<1.5 (7) is satisfied.

### APPENDIX 6

The illumination optical system according to any one of appendices 1 to 5,
wherein in a case where a radius of the light guide is defined as G,
Conditional Expression (8) represented by 1<C/G<1.5 (8) is satisfied.

### APPENDIX 7

The illumination optical system according to any one of appendices 1 to 6,
wherein at least one of the first concave surface portions includes a light diffusion surface.

### APPENDIX 8

The illumination optical system according to any one of appendices 1 to 7,
wherein the first surface has at least one second concave surface portion having a larger curvature radius than the curvature radius of the first concave surface portion at a position closer to the optical axis than the first concave surface portion, and
in a case where a curvature radius of the second concave surface portion closest to the optical axis is defined as R2, and
a distance from an intersection point between the second concave surface portion closest to the optical axis and the optical axis to the second surface in the direction of the optical axis is defined as T,
Conditional Expression (9) represented by 0.55<R2/T<1.3 (9) is satisfied.

### APPENDIX 9

An endoscope comprising:
a light guide; and
the illumination optical system according to any one of appendices 1 to 8.

What is claimed is:

1. An illumination optical system disposed on an emission side of a light guide of an endoscope,
wherein in a case where a surface of the illumination optical system closest to a light guide side is defined as a first surface, and a surface of the illumination optical system closest to an irradiation target side is defined as a second surface,
an outer peripheral surface of the illumination optical system from the first surface to the second surface has a light reflecting surface on a first surface side and has a light absorbing surface on a second surface side,
a stepped surface that is a surface perpendicular to an optical axis of the illumination optical system and that constitutes a step at which an outer diameter dimension changes is formed at a boundary between the light reflecting surface and the light absorbing surface,
the first surface has a plurality of first concave surface portions that have the same curvature radius and are provided at a small-diameter portion having a smaller diameter than a diameter of an outermost diameter portion at which an outer diameter of the illumination optical system is largest, and
in a case where a radius of the small-diameter portion is defined as C,
a radius of the outermost diameter portion is defined as H,
a distance from a position on the first surface closest to the light guide side to the stepped surface in a direction of the optical axis is defined as D,
a distance from an intersection point between the second surface and the optical axis to the stepped surface in the direction of the optical axis is defined as E, and
the curvature radius of the first concave surface portion is defined as R1,
Conditional Expressions (1), (2), and (3) represented by
0.4<C/H<0.95 (1),
0.45<D/(D+E)<0.95 (2), and
0.05<R1/H<0.5 (3) are satisfied.

2. The illumination optical system according to claim 1,
wherein in a case where an interval between surface apexes of the first concave surface portions adjacent to each other on the surface perpendicular to the optical axis is defined as P,
Conditional Expression (4) represented by 0.8<(C−P)/D<2 (4) is satisfied.

3. The illumination optical system according to claim 1,
wherein in a case where an interval between surface apexes of the first concave surface portions adjacent to each other on the surface perpendicular to the optical axis is defined as P,
Conditional Expression (5) represented by 0.02< (2×R1−P)/C<0.25 (5) is satisfied.

4. The illumination optical system according to claim 1,
wherein in a case where an interval between surface apexes of the first concave surface portions adjacent to each other on the surface perpendicular to the optical axis is defined as P,
Conditional Expression (6) represented by
$$0.04 < \frac{R 1 - \sqrt{R {1}^{2} - {( P / 2 )}^{2}}}{D} < 0.3 \qquad ( 6 )$$
is satisfied.

5. The illumination optical system according to claim 1,
wherein Conditional Expression (7) represented by 0.9<H/(D+E)<1.5 (7) is satisfied.

6. The illumination optical system according to claim 1,
wherein in a case where a radius of the light guide is defined as G,
Conditional Expression (8) represented by 1<C/G<1.5 (8) is satisfied.

7. The illumination optical system according to claim 1,
wherein at least one of the first concave surface portions includes a light diffusion surface.

8. The illumination optical system according to claim 1,
wherein the first surface has at least one second concave surface portion having a larger curvature radius than the curvature radius of the first concave surface portion at a position closer to the optical axis than the first concave surface portion, and
in a case where a curvature radius of the second concave surface portion closest to the optical axis is defined as R2, and
a distance from an intersection point between the second concave surface portion closest to the optical axis and the optical axis to the second surface in the direction of the optical axis is defined as T,
Conditional Expression (9) represented by 0.55<R2/T<1.3 (9) is satisfied.

9. An endoscope comprising:
a light guide; and
the illumination optical system according to claim 1.
